(19) United States
(12) Patent Application Publication
(10) Pub. No.: US 2025/0056403 A1
(43) Pub. Date: Feb. 13, 2025

(54) STATE TRANSITION OF CELL DISCONTINUOUS OPERATION

(71) Applicant: Nokia Technologies Oy, Espoo (FI)

(72) Inventors: Naizheng ZHENG, Beijing (CN); Ahlem Khlass, Massy (FR); Mads Lauridsen, Aalborg (DK); Daniela Laselva, Aalborg (DK); Lei Du, Beijing (CN); Chunli Wu, Beijing (CN)

(21) Appl. No.: 18/779,543

(22) Filed: Jul. 22, 2024

(30) Foreign Application Priority Data
Aug. 10, 2023 (WO) PCT/CN2023/112306

(51) Int. Cl. H04W 52/02; H04W 76/28

(52) U.S. Cl. CPC H04W 52/0203; H04W 76/28

(57) ABSTRACT

Example embodiments of the present disclosure are related to state transition of a cell. An apparatus receives a monitoring occasion configuration for control information related to a discontinuous operation pattern of a cell, the monitoring occasion configuration indicating at least one monitoring occasion that is before activation of the discontinuous operation pattern or during a time when the discontinuous operation pattern is activated. The apparatus monitors the control information from the device at the at least one monitoring occasion, the control information at least indicating a state transition of the cell between an active state and a non-active state; and based on receiving the control information from the device, and determines, from the control information, the state transition of the cell between the active state and the non-active state.

Various example embodiments of the present disclosure generally relate to the field of telecommunication and in particular, to methods, devices, apparatuses and computer readable storage medium for state transition of a cell in a cell discontinuous reception (DRX) and/or cell discontinuous transmission (DTX) operation.

### BACKGROUND

Network energy saving (NES) is a hot topic in communication field. For example, cell DTX/DRX is a technique proposed at network device side in order to save power. Cell DTX/DRX allows the network device to sleep within a DTX/DRX cycle when there are no packets to be transmitted/received. Therefore, it is worth studying on how to (de)-activate the cell DTX/DRX.

### SUMMARY

In a first aspect of the present disclosure, there is provided an apparatus. The apparatus comprises at least one processor; and at least one memory storing instructions that, when executed by the at least one processor, cause the apparatus at least to perform: receiving, from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; monitoring the control information from the device at the at least one monitoring occasion, the control information at least indicating a state transition of the cell between an active state and a non-active state; and based on receiving the control information from the device, determining, from the control information, the state transition of the cell between the active state and the non-active state.

In a second aspect of the present disclosure, there is provided an apparatus. The apparatus comprises at least one processor; and at least one memory storing instructions that, when executed by the at least one processor, cause the device at least to perform: transmitting, to an apparatus, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; and transmitting control information to the apparatus at the at least one monitoring occasion before activation of the discontinuous operation pattern or during a time when the discontinuous operation pattern is activated, the control information at least indicating a state transition of the cell between an active state and a non-active state.

In a third aspect of the present disclosure, there is provided a method. The method comprises: receiving, from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; monitoring the control information from the device at the at least one monitoring occasion, the control information at least indicating a state transition of the cell between an active state and a non-active state; and based on receiving the control information from the device, determining, from the control information, the state transition of the cell between the active state and the non-active state.

In a fourth aspect of the present disclosure, there is provided a method. The method comprises: transmitting, to an apparatus, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; and transmitting control information to the apparatus at the at least one monitoring occasion before activation of the discontinuous operation pattern or during a time when the discontinuous operation pattern is activated, the control information at least indicating a state transition of the cell between an active state and a non-active state.

In a fifth aspect of the present disclosure, there is provided a first apparatus. The first apparatus comprises means for receiving, from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; means for monitoring the control information from the device at the at least one monitoring occasion, the control information at least indicating a state transition of the cell between an active state and a non-active state; and means for based on receiving the control information from the device, determining, from the control information, the state transition of the cell between the active state and the non-active state.

In a sixth aspect of the present disclosure, there is provided a second apparatus. The second apparatus comprises means for transmitting, to an apparatus, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; and means for transmitting control information to the apparatus at the at least one monitoring occasion before activation of the discontinuous operation pattern or during a time when the discontinuous operation pattern is activated, the control information at least indicating a state transition of the cell between an active state and a non-active state.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a (de)-activation indication for a cell DTX/DRX pattern;

FIG. 3 illustrates a flowchart of a signaling flow for cell state transition according some example embodiments of the present disclosure;

FIG. 4 illustrates an example of DCI monitoring occasions during normal network operations and/or during an active period of a cell DTX/DRX pattern according to some example embodiments of the present disclosure;

FIG. 5 illustrates an example of DCI monitoring occasions during a cell DTX non-active period, with MO configured relative to the RRC configured active-to-non-active switching boundary of the activated cell DTX/DRX pattern according to some example embodiments of the present disclosure;

FIG. 6 illustrates an example of DCI monitoring occasions during a cell DTX non-active period, with MO configured relative to the latest active-to-non-active switching boundary triggered by group-common DCI according to some example embodiments of the present disclosure according to some example embodiments of the present disclosure;

FIG. 7 illustrates an example of reception of group-common DCI in the configured MO during a non-active period of a cell DTX/DRX pattern according to some example embodiments of the present disclosure;

FIG. 8 illustrates an example of configured timer expiration for a temporary active time during the cell DTX non-active period according to some example embodiments of the present disclosure;

FIG. 9 illustrates an example of timer overlap with the next active period of RRC configured cell DTX according to some example embodiments of the present disclosure;

FIG. 10 illustrates a flowchart of a method implemented at a first apparatus according to some example embodiments of the present disclosure;

FIG. 11 illustrates a flowchart of a method implemented at a second apparatus according to some example embodiments of the present disclosure;

FIG. 12 illustrates a simplified block diagram of a device that is suitable for implementing example embodiments of the present disclosure; and

FIG. 13 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “RRC connected state” or “RRC connected mode” used herein may refer to a state in which service radio bearer and data radio bearer are allocated for the terminal device. The term “RRC idle state” or “RRC idle mode” used herein may refer to a state where the terminal device is switched on but does not have any established RRC connection. The term “RRC non-active state” or “RRC non-active mode” used herein may refer to a state when there is an RRC connection that has been suspended.

As used herein, the term “cell discontinuous reception (DRX)” used herein may refer to a technique that allows a network device to receive data in a period and sleep within another period when there are no packets to be received. The term “cell discontinuous transmission (DTX)” used herein refers to a technique that allows the network device to transmit data in a period and sleep within another period when there are no packets to be transmitted. The cell DRX/DTX can be used in mobile communication to save energy of the network device.

The term “on duration” or “active period” used for cell DRX refers to a time period during which the network device is able to monitor a channel, for example, a physical control channel or a physical shared channel, and receive data or control information on the channel. The term “DRX period” or “opportunity for DRX” or “off time” or “off duration” or “non-active/inactive period” used for cell DRX refers to a time period during which the network device does not monitor the channel and does not receive data or control information on the channel. The term “DRX cycle” or “DRX periodicity” used herein comprises an on-duration during which the network device may monitor the channel and a DRX period during which the network device can skip reception of channel.

The term “on duration” or “active period” used for cell DTX refers to a time period during which the network device is able to transmit data or control information on a channel, for example, a physical control channel or a physical shared channel. The term “DTX period” or “opportunity for DTX” or “off time” or “off duration” or “non-active/inactive period” for cell DTX used herein refers to a time period during which the network device does not transmit data or control information on the channel. The term “DTX cycle” or “DTX periodicity” used herein comprises an on-duration during which the network device may transmit data or control information on the channel and a DTX period during which the network device can skip transmission of channel.

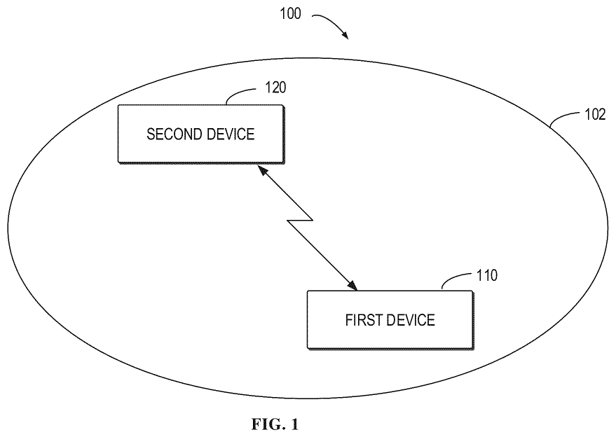

FIG. 1 illustrates an example communication environment 100 in which example embodiments of the present disclosure can be implemented. In the communication environment 100, a first device 110 and a second device 120 may communicate with each other.

The first device 110 (or referred to as a first apparatus) may be a terminal device, such as a UE. The second device 120 (or referred to as a second apparatus) may be a network device, such as gNB. The first device 110 may be in a cell 102 which is the serving cell in serving coverage of the second device 120.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure are related to network energy saving (NES). The work items related to NES includes the following objective. It aims to specify enhancement on the cell DTX/DRX mechanism including the alignment of cell DTX/DRX and UE DRX in RRC_CONNECTED mode, and inter-node information exchange on cell DTX/DRX.

It has been agreed that a new group-common DCI format 2_x will be introduced in NES for the purpose of activation and de-activation of cell DTX/DRX pattern. The design details on this new DCI format are still open.

For the group common L1 signaling using physical downlink control channel (PDCCH) for cell DTX/DRX activation and deactivation, there is an option that based on new DCI format 2_X, the DCI size budget is not increased, the number of required blind decoding (BDs) is not increased. It needs to further study whether PDCCH monitoring configuration for the new DCI format is identical to PDCCH monitoring configuration for DCI format 2_6 if the UE monitors both DCI formats.

Some agreements are reached relating to the design of the new group-common DCI format 2_x. The agreements include the followings. A periodic cell DTX/DRX configuration is explicitly signalled to the UEs. A periodic cell DTX/DRX pattern is configured by UE specific RRC signalling. The cell DTX/DRX configuration contains at least: periodicity, start slot/offset, on duration. As a baseline cell DTX/DRX is activated/deactivated implicitly by RRC signalling, i.e., activated immediately once configured by RRC and deactivated once the RRC configuration is released. There is a benefit with L1 signalling for cell DTX/DRX activation/deactivation, and the design details are needed. The understanding for the gNB scheduling behaviour for new transmissions during a cell DTX non-active period is that the gNB does not schedule UE-specific dynamic grants/assignments, even if the UE is in Cell DRX Active Time. UE may not monitor PDCCH for dynamic grants/assignments for new transmissions during a cell DTX non-active period, even if the UE is in Cell DRX Active time.

Some further agreements include that when the retransmission timer is running (if Cell DRX is configured), the UE is expected to monitor PDCCH, like in legacy. It is up to the network whether it schedules retransmissions out of the cell DTX active period, i.e., when the DRX retransmission timer is running, the UE should monitor PDCCH regardless of the cell DTX. Once gNB recognizes there is an emergency call or public safety related service (e.g. multimedia priority service (MPS) or mission critical service (MCS)), the network should ensure there is no impact to the emergency call (e.g. may deactivate cell DTX/DRX).

Based on the above quoted RAN2 agreements, it is understood that a single cell DTX and DRX pattern may be configured separately to the UEs with UE-specific RRC signalling, where the cell DTX/DRX pattern configuration contains at least, periodicity, start slot/offset, on duration. By default, the cell DTX/DRX pattern can be activated or deactivated by UE-specific RRC signalling. And the UE is not expected to monitor the PDCCH for dynamic grants/assignments for new TBs during a cell DTX non-active period, even if the UE is in the active time of C-DRX. In the meanwhile, to deal with the emergency call or public safety related services, especially during the non-active period of a cell DTX/DRX pattern, the network should ensure there is no impact to the emergency call, e.g. the network may deactivate the cell DTX/DRX operation.

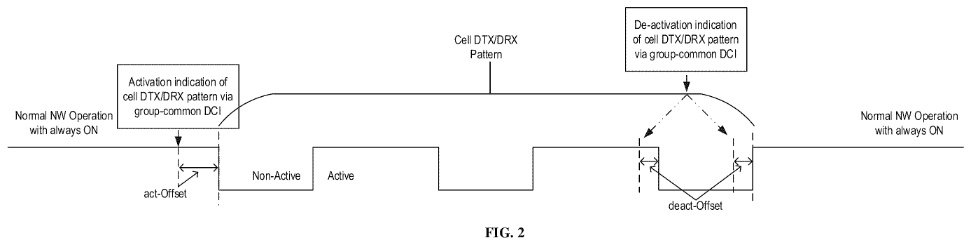

There is an assumption that a new Radio Network Temporary Identifier (RNTI), nes-RNTI, may have to be introduced, i.e. for DCI format 2_x with Cyclic Redundancy Check (CRC) scrambled by nes-RNTI. For activation and deactivation indication of cell DTX/DRX configuration via group-common DCI format 2_x, one approach is provided as an example shown in FIG. 2. For activation of cell DTX/DRX pattern, a start of the search-time (act-Offset) of DCI format 2_x with CRC scrambled by nes-RNTI, similar to the ps-Offset in DCP-Config-r16, can be introduced, where the introduced act-Offset can be relative to the start of the configured cell DTX/DRX pattern. In one example, the act-Offset can be relative to the start of a subsequent non-active period of the configured cell DTX/DRX pattern, as showed in FIG. 2. In another example, the act-Offset can indicate the start of a subsequent active period of the configured cell DTX/DRX pattern.

For deactivation of a cell DTX/DRX pattern, the group-common DCI format 2_x can be monitored either in the active time or non-active time of cell DTX/DRX. And another start of search-time (deact-Offset) for UE searching of DCI format 2_x with CRC scrambled by nes-RNTI can be introduced, where the deact-Offset can be relative either to active-to-non-active switching boundary in active period, or to Nonactive-to-Active switching boundary in non-active period (i.e., back to normal network (NW) operation and the cell DTX/DRX pattern is deactivated), as shown in FIG. 2.

For the approach described above, the network operation based on the configured act-Offset/deact-Offset with relative to the cell DTX/DRX configuration can be rather semi-static. Further, more dynamic network operation based on the new DCI format 2_x is expected to provide better performance and flexibility, i.e. in terms of traffic load variation.

Moreover, so far it is unclear on how long the duration of non-active period of a cell DTX/DRX pattern may be. Practically, it can be in the range of 100 ms or 10 s, e.g. depending on the network sleeping mode, i.e. light sleep or deep sleep. Furthermore, how to handle the emergency call and public safety related services, especially during long non-active periods is still an open question that require to be further addressed.

As stated above, there were no discussion yet on details on the new group-common DCI design for cell DTX/DRX (de)-activation indication. Also, so far it is still open on how to handle the emergence call and public safety related services, especially during the very long non-active period.

According to some example embodiments of the present disclosure, there is provided a solution for cell state transition. In this solution, a first device (e.g., a terminal device) is provided by a second device (e.g., a network device) a monitoring occasion configuration for control information related to a discontinuous operation pattern of a cell, to indicate at least one monitoring occasion that is before activation of the discontinuous operation pattern or during the time when the discontinuous operation pattern is activated. According to this configuration, the first device may additionally monitor the control information from the second device before the discontinuous operation pattern is activated or after the discontinuous operation pattern is activated. The second device can dynamically transit the cell between an active state and a non-active state according to actual requirement. This solution provides more dynamic network operations with activation/deactivation of cell DTX/DRX. In addition, it is also possible to handle the emergence calls and public safety related services during a non-active period of the cell DTX/DRX, especially during the very long non-active period.

Example embodiments of the present disclosure will be described in detail below with reference to the accompanying drawings.

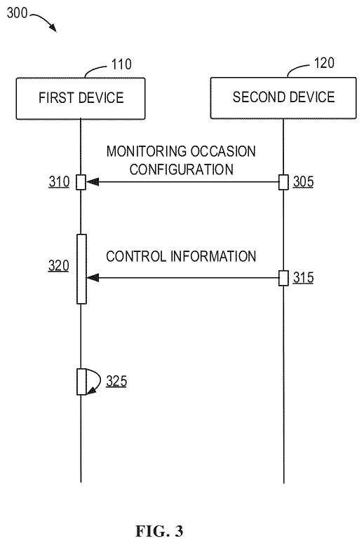

FIG. 3 illustrates a flowchart of a signaling flow 300 for cell state transition according some example embodiments of the present disclosure. For the purposes of discussion, the signaling flow 200 will be discussed with reference to FIG. 1, for example, by using the first device 110 and the second device 120. For example, the first device 110 may be or may be comprised in a user equipment, and the second device 120 may be a network device.

As shown in FIG. 3, a second device 120 transmits (305) to the first device 110 a monitoring occasion configuration for control information related to a discontinuous operation pattern of a cell. The first device 110 receives (310) from the second device 120 the monitoring occasion configuration for control information related to a discontinuous operation pattern of a cell.

The discontinuous operation pattern comprises a pattern of at least one of a DTX operation or/and a DRX operation. In the following, for the purpose of discussion, a “cell DTX/DRX pattern” and “discontinuous operation pattern” are used interchangeably, referring to a pattern of a DTX operation, a pattern of a DRX operation, or a pattern of both DTX and DRX operations. A discontinuous operation pattern may comprise one or more periodicities of active period and non-active period, where during an active period the cell is in an active state for transmission and/or reception, and during a non-active period the cell is in a non-active state, without transmission and/or reception.

The monitoring occasion configuration for control information transmitted from the second device 120 to the first device 110 indicates at least one monitoring occasion (MO) that is before activation of the discontinuous operation pattern or during a time when the discontinuous operation pattern is activated. A MO may also be referred to as a PDCCH monitoring occasion or DCI monitoring occasion, for monitoring control information in PDCCH. The cell may be assumed to be always in an active state (or ON state) or is deactivated (or OFF state) if the discontinuous operation pattern is not yet activated. The time when the discontinuous operation pattern is activated may include an active time of the discontinuous operation pattern (the active period(s) of the discontinuous operation pattern) and a non-active time of the discontinuous operation pattern (the non-active period(s) of the discontinuous operation pattern).

In some example embodiments, the monitoring occasion configuration is configured with a search space type of common search space associated with a predetermined group-common downlink control information format. In some example embodiments, the control information to be monitored in a configured monitoring occasion may comprise DCI, and may be transmitted in a predetermined DCI format, e.g., DCI format 2_x, or group-common DCI format 2_x. In this example, the monitoring occasions for DCI-Format 2_x may be configured (in a common search space (CSS), e.g., with Type3-CSS) with a SearchSpace associated with the searchSpaceType group-common DCI-Format 2_x. By using the DCI format, the second device 120 may transmit control information related to a discontinuous operation pattern of a cell to a group of first devices within the cell.

According to the monitoring occasion configuration, the second device 120 transmits (315) control information to the first device 110 at the at least one monitoring occasion before activation of the discontinuous operation pattern or during a time when the discontinuous operation pattern is activated. The control information at least indicates a state transition of the cell between an active state (e.g., an active DTX and/or DRX state, or sometimes an active state for short) and a non-active state (e.g., a non-active DTX and/or DRX state, or sometimes a non-active or inactive state for short). In some examples, the control information may include DCI in the predetermined DCI format, e.g., DCI format 2_x, or group-common DCI format 2_x. In some example embodiments, the second device 120 may transmit the control information to a group of first devices, e.g., through the group-common DCI format.

According to the monitoring occasion configuration, the first device 110 monitors (320) the control information from the second device 120 at the at least one monitoring occasion. The control information at least indicates a state transition of the cell between an active state and a non-active state, e.g., transitioning from the active state to the non-active state or vice versa. The active state may include an always ON state when the discontinuous operation pattern is not activated, and an active discontinuous operation state when the discontinuous operation pattern is activated. The non-active state may include an OFF state when the discontinuous operation pattern is not activated, and a non-active discontinuous operation state when the discontinuous operation pattern is activated.

Depending on the transmission of the control information at the side of the second device 120, the first device 110 may receive control information from the second device 120 at a certain monitoring occasion. For example, the first device 110 may detect and successfully decode the control information, e.g., in PDCCH from the second device 120.

Based on receiving the control information from the second device 120, the first device 110 determines (325), from the control information, the state transition of the cell between the active state and the non-active state. In an example, the first device 110 determines, based on the control information, state transition of the cell from the active state to the non-active state. In another example, the first device 110 determines, based on the control information, state transition of the cell from the non-active state to the active state. The determination may be based on the control information and may be performed in accordance with the control information (i.e. what the control information indicates).

For example, based on the cell being in or transitioning to active state, the first device 110 may be configured to monitor the PDCCH and monitor reference signals if C-DRX is configured for the first device 110 and the first device 110 is in active time of its own C-DRX cycle (i.e. C-DRX active time).

For example, based on the cell being in or transitioning to non-active state, the first device 110 may be configured to assume that all or at least most signals are not transmitted, e.g. no CSI-RS and no PRS. However, it is possible that at least some signals are still transmitted. Thus, in this example, the first device 110 may be configured to not monitor all or at least most signals. For example, first device 110 may be configured to not monitor at least CSI-RS and/or PRS.

The second device 120 may control the state of the cell to transition between the active state and the non-active state, for the purpose of energy saving and for transmission and/or reception of information. By configuring the monitoring occasions that are before activation of the discontinuous operation pattern or during an active time of the discontinuous pattern, the second device 120 may dynamically control the state transition of the cell and indicate the same to the first device 110. Some example embodiments will be discussed in detail below.

In some example embodiments, the monitoring occasion configuration comprises a first monitoring occasion configuration for control information before the activation of the discontinuous operation pattern, for example, to indicate one or more monitoring before the activation of the discontinuous operation pattern. The first monitoring occasion configuration may comprise at least one of the following: a first reference boundary, the first reference boundary comprising a boundary of a time-domain resource unit, a first start offset relative to the first reference boundary to indicate when the first monitoring occasion configuration is applied, or a first periodicity of monitoring occasions. In some example embodiments, the first reference boundary may comprise a boundary of a system frame number (SFN), a slot, or a symbol. Such configuration may allow the first device 110 to determine the monitoring occasion(s) for the control information related to the discontinuous operation pattern of the cell that is before the activation of the discontinuous operation pattern.

In some example embodiments, while a cell DTX/DRX pattern is not activated, the monitoring occasion(s) for DCI-Format 2_x may be configured (in common search space, e.g. with Type3-CSS) with a SearchSpace associated with the searchSpaceType group-common DCI-Format 2_x, with a start offset (monitoringSlotPeriodicityAndOffset) relative to a SFN, slot, or symbol boundary.

In some example embodiments, the control information monitored and received by the first device 110 before the activation of the discontinuous operation pattern may at least comprise a first indication of transitioning the cell from the active state to the non-active state before a configured start of the discontinuous operation pattern. In some example embodiments, one of the content information elements (IEs) in the control information (e.g., in DCI-Format 2_x) indicates a network transition from cell DTX/DRX Active (Time)-to-Nonactive (Time) (or generally a network transition from cell DTX/DRX ON-to-OFF), the first indication can be transmitted by the second device 120 and monitored by the first device 110. In some example embodiments, the first indication in the control information may indicate that the network activates a DTX/DRX pattern starting with a non-active period. Therefore, the cell transitions from an active state to a non-active state. The first indication in the control information may also be called ‘Cell-Goes-to-sleep’ or simply ‘go-to-sleep’ indication. Based on receiving the control information before the configured start of the discontinuous operation pattern, the first device 110 may determine from the first indication the state transition of the cell to the non-active state.

In some example embodiments, the monitoring occasion configuration comprises a second monitoring occasion configuration for control information during an active period of the discontinuous operation pattern. The second monitoring occasion configuration may comprise at least one of the following: a second reference boundary, the second reference boundary comprising a reference time within the active period of the discontinuous operation pattern (e.g., a start of the active period or an end of the active period), a second start offset relative to the second reference boundary to indicate when the second monitoring occasion configuration is applied, or a second periodicity of monitoring occasions. Such configuration may allow the first device 110 to determine the monitoring occasion(s) for the control information related to the discontinuous operation pattern of the cell that is during an active period of the discontinuous operation pattern. In some example embodiments, the first device 110 may be configured, e.g., via RRC configuration information, with other monitoring occasions to activate or deactivate the discontinuous operation pattern (the cell DTX/DRX pattern).

In some example embodiments, during an active period of a configured and activated cell DTX/DRX pattern, the monitoring occasions for DCI (e.g., in DCI-Format 2_x) may be configured (in common search space, e.g. with Type3-CSS) with a Search Space associated with the search Space Type of group-common DCI-Format 2_x, with a parameter monitoringSlotPeriodicityAndOffset/duration/monitoringSymbolsWithinSlot relative to (i.e. after) the RRC configured active period of cell DTX/DRX.

In some example embodiments, the control information monitored and received by the first device 110 during the active period of the discontinuous operation pattern may at least comprise a second indication of early termination of the active period or a third indication of deactivation of the discontinuous operation pattern. In some example embodiments, the content of DCI-Format 2_x indicates the state transition of the cell from the active state to the non-active state (which can be also called ‘Early Termination of Cell Active Period indication’) or Cell DTX/DRX deactivation (i.e., a cell transition to normal operations).

Based on receiving the control information during the active period of the discontinuous operation pattern, the first device 110 may determine, from the second indication or the third indication, that the cell is transitioned from the active state to the non-active state or that the discontinuous operation pattern is deactivated. In some example embodiments, if the detected control information comprises the second indication of early termination of the active period, the first device 110 may determine a shifted start of a new non-active-to-active periodicity starting with a non-active period or a start of a non-active period followed by a new non-active-to-active periodicity in the discontinuous operation pattern. For example, the transition indication from active-to-non-active can be interpreted as a shifted start of a new cell DTX/DRX cycle starting with a non-active period or as a non-Active time followed by a new cell DTX/DRX cycle.

In some example embodiments, for behaviour of the first device on receiving of the “Cell-Goes-to-sleep indication” (i.e., the first indication) or “Early Termination of Cell Active Period indication”, the first device 110 may consider that the cell transitions from ON-to-OFF or active-to-non-active, and afterwards consider the cell to be in a non-active discontinuous operation (DTX/DRX) state.

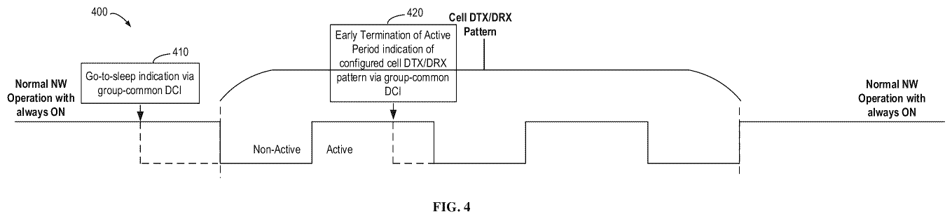

FIG. 4 illustrates an example 400 of DCI monitoring occasions during normal network operations and/or during an active period of a cell DTX/DRX pattern. As shown in FIG. 4, the second device 120 transmits and the first device 110 receives a “Go-to-sleep indication” 410 via group-common DCI at a configured monitoring occasion while the cell DTX/DRX pattern is not activated (e.g., while the network operation with a state of always ON). Upon receiving the “Go-to-sleep indication” 410, the first device 110 determines that the network activates the cell DTX/DRX pattern starting within a non-active period, and the cell is transitioned from an active (ON) state to a non-active state. The monitoring occasion for the indication 410 may be configured with a SFN, slot or symbol boundary and a start offset relative to the SFN, slot or symbol boundary.

Further, as shown in FIG. 4, the second device 120 transmits and the first device 110 receives a “Early Termination of Active Period indication” 420 of the configured cell DTX/DRX pattern via group-common DCI at a configured monitoring occasion during an active period of a configured and activated cell DTX/DRX”, indicating the cell state transition from active to non-active. The monitoring occasion for the indication 420 may be configured with a boundary of a reference time within the active period of the cell DTX/DRX pattern (e.g., a start of the active period or an end of the active period) and a second start offset relative to the boundary of the reference time.

In some example embodiments, the monitoring occasion configuration comprises a third monitoring occasion configuration for control information during a non-active period of an activated discontinuous operation pattern, the third monitoring occasion configuration comprising at least one of the following: a third reference boundary, or a third start offset relative to the third reference boundary to indicate when the third monitoring occasion configuration is applied. In some embodiments, the third monitoring occasion configuration may further comprise a third periodicity of monitoring occasions. Such configuration may allow the first device 110 to determine the monitoring occasion(s) for the control information related to the discontinuous operation pattern of the cell that is during a non-active period of the discontinuous operation pattern.

In some example embodiments, the third reference boundary may comprise a configured boundary of switching from an active period to a non-active period of the discontinuous operation pattern. For example, the third reference boundary may be configured with a monitoringSlotPeriodicityAndOffset relative to the RRC configured active-to-non-active switching boundary of the activated cell DTX/DRX pattern. In some example embodiments, the third reference boundary may comprise a latest boundary of switching from an active period to a non-active period of the discontinuous operation pattern triggered by the control information from the second device 120 (e.g., through the “Early Termination of Active Period indication” or the “Go-to-sleep indication”). In this example, the third reference boundary may be configured with a monitoringSlotPeriodicityAndOffset relative to the latest active-to-non-active switching boundary triggered by group-common DCI format 2_x.

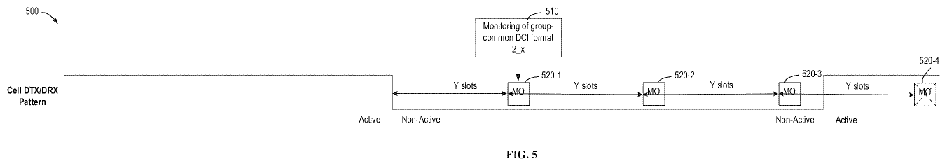

In some example embodiments, within a non-active period of a cell DTX/DRX pattern, the monitoring occasion(s) for the first device 110 to monitor reception of group-common DCI may be configured by the network, for example, to be able to handle emergency calls. As shown in an example 500 of FIG. 5, monitoring occasion(s) within a non-active period of a cell DTX/DRX pattern may be configured, e.g. using a monitoringSlotPeriodicityAndOffset relative to the RRC configured active-to-non-active switching boundary of the activated cell DTX/DRX pattern. Further, a periodicity of “Y slots” may be configured for periodic monitoring occasions, e.g., to configure MOs 520-1, 520-2, 520-3, 520-4, etc. The first device 110 may perform monitoring 510 of group-common DCI format 2_x at MO 520-1, and other monitoring occasions.

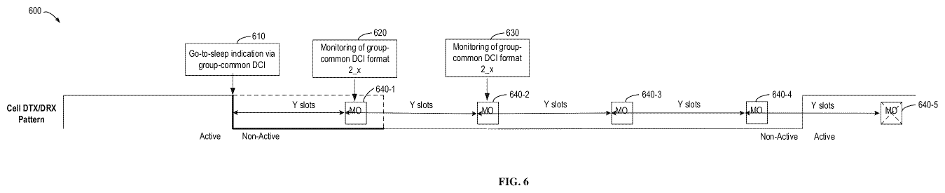

Alternatively, as shown in FIG. 6, monitoring occasion(s) within a non-active period of a cell DTX/DRX pattern may also be configured using a monitoringSlotPeriodicityAndOffset relative to the latest active-to-non-active switching boundary triggered by group-common DCI format 2_x (e.g., by a “Go-to-sleep indication” 610 received via group-common DCI). Further, a periodicity of “Y slots” may be configured for periodic monitoring occasions, e.g., to configure MOs 640-1, 640-2, 640-3, 640-4, 640-5, etc. The first device 110 may perform monitoring 620, 630 of group-common DCI format 2_x at MO 640-1, MO 640-2, and other monitoring occasions.

In some example embodiments, the third monitoring occasion configuration configures a first plurality of monitoring occasions for monitoring control information during a non-active period of an activated discontinuous operation pattern. In this example, the first device 110 may skip monitoring of the control information at at least one of the first plurality of monitoring occasions monitoring occasion that occurs within an active period of the discontinuous operation pattern; and monitors the control information at at least one of the first plurality of monitoring occasions that occurs within a non-active period of the discontinuous operation pattern. In some example embodiments, one or more configured MOs can be disabled, skipped, omitted, terminated during an active period of the cell DTX/DRX pattern, and enabled or re-activated again after a subsequent active-to-non-active switching and within the subsequent non-active period of the cell DTX/DRX pattern. As shown in the example 500 of FIG. 5, MO 520-4 occurred within the active period and may be skipped. As shown in the example 600 of FIG. 6, MO 640-5 occurred within the active period and may be skipped.

In some example embodiments, the control information may further comprise at least one of the following: a fourth indication of transitioning from the non-active state to the active state, a fifth indication of not transitioning from the non-active state to the active state, or a temporary active duration.

In some example embodiments, during the non-active period of the activated discontinuous operation pattern, if no control information is detected according to the third monitoring occasion configuration, the first device 110 may determine that the cell is in the non-active state. In some example embodiments, during the non-active period of the activated discontinuous operation pattern, if the first device 110 receives control information in a configured monitoring occasion and the control information comprises the fifth indication of not transitioning from the non-active state to an active state, the first device 110 may determine that the cell is in the non-active state. In some example embodiments, during the non-active period of the activated discontinuous operation pattern, if the received control information comprises the fourth indication of transitioning from the non-active state to the active state, the first device 110 may determine the cell state transition from the non-active state to the active state upon the detection of the control information or after a predetermined delay of time.

In some example embodiments, if no DCI format 2_x is received or if it is received and does not indicate switch to active time in a configured MO during a non-active period of a cell DTX/DRX pattern, the first device 110 may consider the cell is still in non-active time (i.e. no Nonactive-To-Active switching). As shown in an example 700 of FIG. 7, based on receiving the “go-to-sleep indication” 710 via group-common DCI during an active period of the cell DTX/DRX pattern, the first device 110 determines that the cell is transitioned into a non-active state. The first device 110 keeps monitoring of group-common DCI at configured MOs 730-1, 730-2, and 730-3 during the non-active time of the cell DTX/DRX pattern. Since no control information is received at MO 730-1 and MO 730-3, the first device 110 determines that the cell is still in non-active time.

In some example embodiments, on reception of group-common DCI in a configured MO during the non-active period of the cell DTX/DRX pattern, the first device 110 may determine nonactive-to-active switching of the cell, as shown in MO 730-2 in FIG. 7.

In some example embodiments, the nonactive-to-active switching may be assumed immediately by the first device 110 or after a certain duration after the reception of the DCI, which can be, configured by the network (e.g., by indicating the temporary active duration in the control information) or may be pre-defined to the first device 110. In some example embodiments, in a non-active period of the cell DTX/DRX pattern, based on determining, from the received control information, that the cell is transitioned from the non-active state to the active state, the first device 110 may start a timer with the temporary active duration and determine that the cell is in the active state within a duration when the timer is running. For example, the first device 110 may receive the fourth indication of transitioning from the non-active state to the active state during the non-active period of the cell DTX/DRX pattern. Based on the fourth indication, the first device 110 may determine that the cell is temporarily in an active state. The first device 110 may thus start the timer with the configured or pre-defined temporary active duration.

In some example embodiments, a configured timer can be started (where the configured timer duration determines the temporary active time triggered by the group-common DCI during the non-active period of the cell DTX/DRX pattern). As shown in FIG. 7, group-common DCI 720 is received at MO 730-2, indicating a temporary activation of the cell during the non-active period of the DTX/DRX pattern. Accordingly, an active period is triggered or activated after MO 730-2 during the non-active period of the cell DTX/DRX pattern. A timer may be set with the temporary active duration.

In some example embodiments, the temporary active duration may be determined based on a configured duration of an active period of the discontinuous operation pattern. In some example embodiments, alternatively, a different timer than the active period timer of the cell DTX/DRX pattern can be used after a non-active-to-active switching in the non-active period. In some example embodiments, the temporary active duration may be determined based on a duration determined based on a minimum delay related to a service to be performed during the non-active period, and/or any other requirements/configurations. In some example embodiments, the timer value is commonly configured by the second device 120 to all first devices 110, which value can reflect e.g., the minimum delay to notify the first devices 110 of an emergency call and/or public safety related services.

In some example embodiments, the operations that are allowed when the configured timer is running is configurable by the network. In some example embodiments, the first device 110 may receive, from the second device 120, configuration information indicating allowed operations to be performed within a duration when the timer is running. The configuration information may be included in the received control information, e.g., group-common DCI or may be separately configured.

In some example embodiments, the configured timer may be extended. The duration extension may be controlled by the second device 120. The first device 110 may receive, from the second device 120 and within a duration when the timer is running, an indication of an extended running duration of the timer. Thus, the first device 110 may set the timer with the extended running duration.

In some example embodiments, the extended running duration may be limited to x times, or x times of [a duration of the active time in e.g. ms]. In some example embodiments, if the extended running duration is above x, a cell DTX/DRX deactivation on the next MO (i.e., network transition to normal operations) is triggered.

In some example embodiments, the extended running duration may be dynamically configured by the second device 120. In some example embodiments, in case of extension of the configured timer duration, the first device 110 may be configured with a monitoring occasion within the Timer duration. The monitoring occasion configuration may comprise a fourth monitoring occasion configuration for control information within the duration when the timer is running. According to the fourth monitoring occasion configuration, the first device 110 may monitor the control information within the duration when the timer is running. The first device 110 may receive (e.g., detect and successfully decode), at a monitoring occasion, control information at least comprising the indication of an extended running duration of the timer. The control information may be group-common DCI, e.g., in DCI format 2_x.

In some example embodiments, the fourth monitoring occasion configuration comprises at least one of the following: a fourth reference boundary, a fourth start offset relative to the fourth reference boundary to indicate when the fourth monitoring occasion configuration is applied, or a fourth periodicity of monitoring occasions. In some example embodiments, the fourth reference boundary may comprise a monitoring occasion in which the control information comprising the fourth indication of transitioning from the non-active state to the active state is detected, or an expiration of the temporary active duration of the timer.

In some example embodiments, the MO may be configured with monitoringSlotPeriodicityAndOffset relative to the triggering MO (e.g., the MO in which the control information comprising the fourth indication of transitioning from the non-active state to the active state is detected). In some example embodiments, the MO can also be configured with the start of the search-time (ext-Offset) relative to the expiration slot of Timer duration.

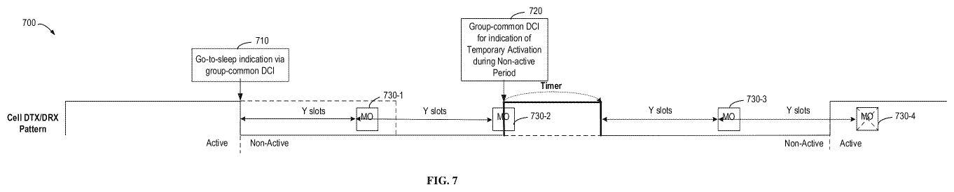

In some example embodiments, if no control information is detected according to the fourth monitoring occasion configuration or if the detected control information comprises an indication of not transitioning to the active state, the first device 110 may determine that the cell transitions to the non-active state after an expiration of the timer. In some example embodiments, if no group-common DCI format 2_x is received in the configured ext-Offset occasion(s) or if it is received and it does not indicate switch to active time, the first device 110 may consider Active-To-Nonactive switching after Timer Expiration, as shown in FIG. 8 after the expiration of the 3^{rd} Timer.

In the example 800 of FIG. 8, based on receiving the “go-to-sleep indication” 810 via group-common DCI during an active period of the cell DTX/DRX pattern, the first device 110 determines that the cell is transitioned into a non-active state. As no group-common DCI is received at MO 840-1, the first device 110 determines that the cell is still in the non-active state. At MO 840-2, the first device 110 receives group-common DCI 820 for indication of temporary activation during the non-active period. The first device 110 starts a timer with a temporary active duration. If a group-common DCI format 2_x is received in the configured ext-Offset occasion, the first device 110 may consider extension of Timer duration (i.e. extension of the active time), and with re-start of Timer after Timer expiration, as shown in FIG. 8 after the second Timer. As no group-common DCI format 2_x is received in the configured ext-Offset occasion(s) or if the received group-common DCI indicate switch to active time, the first device 110 may consider Active-To-Nonactive switching after Timer Expiration, as shown in FIG. 8 after the expiration of the third Timer.

In some example embodiments, the fourth monitoring occasion configuration configures a second plurality of monitoring occasions for monitoring control information. If at least one of the second plurality of monitoring occasions occurs within an active period of the discontinuous operation pattern, the first device 110 may skip monitoring of the control information at the at least one monitoring occasion that occurs within the active period.

In some example embodiments, if a duration when the timer is running is overlapped with an active period following the non-active period of the discontinuous operation pattern, the first device 110 may terminate the timer at a start of the active period. In some example embodiments, if the running Timer is overlapped with coming/subsequent active period of RRC configured cell DTX/DRX, the Timer is terminated, and with skipping of UE monitoring on Timer duration Extension on the configured occasions.

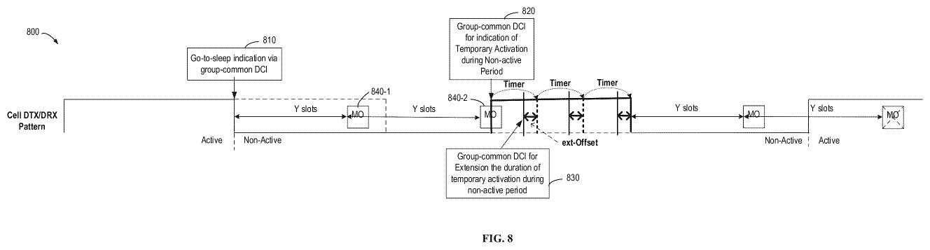

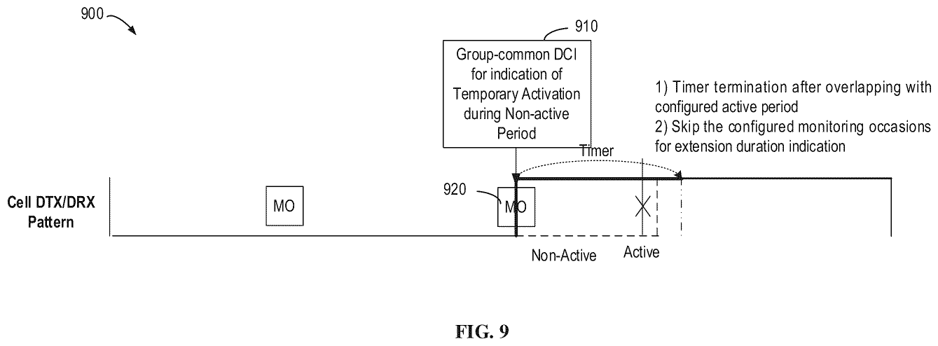

As shown in FIG. 9, monitoring on Timer duration Extension on the configured occasions is skipped. In the example 900 of FIG. 9, the first device 110 receive group-common DCI 910 for indication of temporary activation at MO 920 during the non-active period. A timer is thus set with a temporary activation duration. Since the duration of the timer is overlapped with an active period of the cell DTX/DRX pattern, the first device 110 may terminate the timer after overlapping with the configured active period, and skip the configured monitoring occasions for extension duration indication.

It would be appreciated that the proposed solutions can be applied separately for cell DTX and cell DRX activation/deactivation or jointly (when both cell DTX and cell DRX are configured).

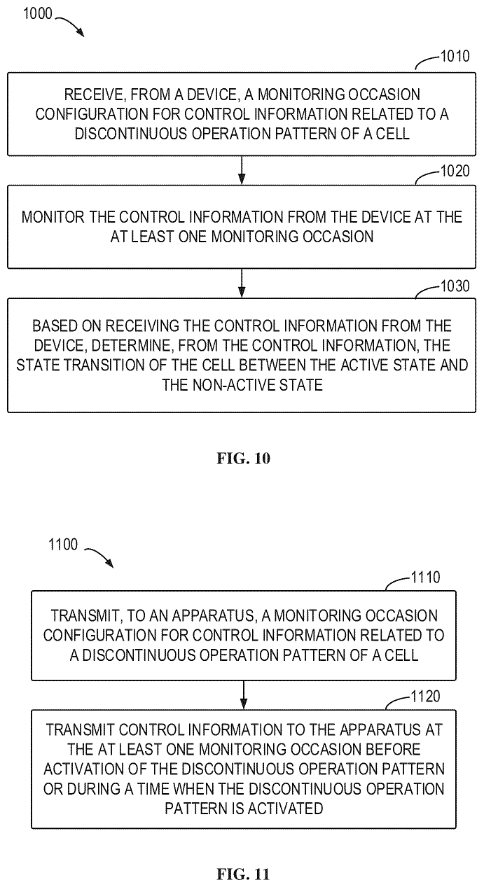

FIG. 10 shows a flowchart of an example method 1000 implemented at an apparatus in accordance with some example embodiments of the present disclosure. For example, the method 1000 may be performed by the first device 110 in FIG. 1

At block 1010, the apparatus receives, from a device (e.g., the second device 120 in FIG. 1), a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated.

At block 1020, the apparatus monitors the control information from the device at the at least one monitoring occasion, the control information at least indicating a state transition of the cell between an active state and a non-active state.

At block 1030, based on receiving the control information from the device, the apparatus determines, from the control information, the state transition of the cell between the active state and the non-active state.

In some example embodiments, the method 1000 comprises: receiving, from the device, downlink control information indicating the monitoring occasion configuration and/or wherein the monitoring occasion configuration is configured with a search space type of common search space associated with a predetermined group-common downlink control information format.

In some example embodiments, the monitoring occasion configuration comprises a first monitoring occasion configuration for control information before the activation of the discontinuous operation pattern, the first monitoring occasion configuration comprising at least one of the following: a first reference boundary, the first reference boundary comprising a boundary of a time-domain resource unit, a first start offset relative to the first reference boundary to indicate when the first monitoring occasion configuration is applied, or a first periodicity of monitoring occasions.

In some example embodiments, the time-domain resource unit comprises a system frame number, a slot, or a symbol.

In some example embodiments, the control information detected before the activation of the discontinuous operation pattern comprises a first indication of transitioning the cell from the active state to the non-active state before a configured start of the discontinuous operation pattern; and the method 1000 comprises: based on receiving the control information before the configured start of the discontinuous operation pattern, determining that the cell is transitioned to the non-active state.

In some example embodiments, the monitoring occasion configuration comprises a second monitoring occasion configuration for control information during an active period of the discontinuous operation pattern, the second monitoring occasion configuration comprising at least one of the following: a second reference boundary, the second reference boundary comprising a reference time within the active period of the discontinuous operation pattern, a second start offset relative to the second reference boundary to indicate when the second monitoring occasion configuration is applied, or a second periodicity of monitoring occasions.

In some example embodiments, the control information detected during the active period of the discontinuous operation pattern comprises a second indication of early termination of the active period or a third indication of deactivation of the discontinuous operation pattern; and wherein the method 1000 further comprises: based on receiving the control information during the active period of the discontinuous operation pattern, determining that the cell is transitioned from the active state to the non-active state or that the discontinuous operation pattern is deactivated.

In some example embodiments, the method 1000 further comprises: in accordance with a determination that the detected control information comprises the second indication of early termination of the active period, determining a shifted start of a new non-active-to-active periodicity starting with a non-active period or a start of a non-active period followed by a new non-active-to-active periodicity in the discontinuous operation pattern.

In some example embodiments, the monitoring occasion configuration comprises a third monitoring occasion configuration for control information during a non-active period of an activated discontinuous operation pattern, the third monitoring occasion configuration comprising at least one of the following: a third reference boundary, the third reference boundary comprising a configured boundary of switching from an active period to a non-active period of the discontinuous operation pattern, or a latest boundary of switching from an active period to a non-active period of the discontinuous operation pattern triggered by the control information from the device; a third start offset relative to the third reference boundary to indicate when the third monitoring occasion configuration is applied; or a third periodicity of monitoring occasions.

In some example embodiments, the third monitoring occasion configuration configures a first plurality of monitoring occasions for monitoring control information, and wherein the method 1000 further comprises: skipping monitoring of the control information at at least one of the first plurality of monitoring occasions monitoring occasion that occurs within an active period of the discontinuous operation pattern; and monitoring the control information at at least one of the first plurality of monitoring occasions that occurs within a non-active period of the discontinuous operation pattern.

In some example embodiments, the control information comprises at least one of the following: a fourth indication of transitioning from the non-active state to the active state, a fifth indication of not transitioning from the non-active state to the active state, or a temporary active duration.

In some example embodiments, the method 1000 further comprises: during the non-active period of the discontinuous operation pattern, in accordance with a determination that no control information is detected according to the third monitoring occasion configuration or in accordance with a determination that the detected control information comprises the fifth indication of not transitioning from the non-active state to an active state, determining that the cell is in the non-active state; and in accordance with a determination that the detected control information comprises the fourth indication of transitioning from the non-active state to the active state, determining that the cell is transitioned from the non-active state to the active state upon the detection of the control information or after a predetermined delay of time.

In some example embodiments, the method 1000 further comprises: based on determining that the cell is transitioned from the non-active state to the active state, starting a timer with a temporary active duration; and determining that the cell is in the active state within a duration when the timer is running.

In some example embodiments, the temporary active duration is determined based on at least one of the following: a configured duration of an active period of the discontinuous operation pattern, or a duration determined based on a minimum delay related to a service to be performed during the non-active period.

In some example embodiments, the method 1000 further comprises: receiving, from the device, configuration information indicating allowed operations to be performed within a duration when the timer is running.

In some example embodiments, the method 1000 further comprises: receiving, from the device and within a duration when the timer is running, an indication of an extended running duration of the timer; and setting the timer with the extended running duration.

In some example embodiments, the monitoring occasion configuration comprises a fourth monitoring occasion configuration for control information within the duration when the timer is running, and wherein the method 1000 further comprises: within the duration when the timer is running, monitoring, according to the fourth monitoring occasion configuration, the control information within the duration when the timer is running; and detecting, at a monitoring occasion, control information at least comprising the indication of an extended running duration of the timer.

In some example embodiments, the fourth monitoring occasion configuration comprises at least one of the following: a fourth reference boundary, the fourth reference boundary comprising a monitoring occasion in which the control information comprising the fourth indication of transitioning from the non-active state to the active state is detected, or an expiration of the temporary active duration of the timer; a fourth start offset relative to the fourth reference boundary to indicate when the fourth monitoring occasion configuration is applied; or a fourth periodicity of monitoring occasions.

In some example embodiments, the method 1000 further comprises: in accordance with a determination that no control information is detected according to the fourth monitoring occasion configuration or in accordance with a determination that the detected control information comprises an indication of not transitioning to the active state, determining that the cell transitions to the non-active state after an expiration of the timer.

In some example embodiments, the fourth monitoring occasion configuration configures a second plurality of monitoring occasions for monitoring control information, and the method 1000 further comprises: in accordance with a determination that at least one of the second plurality of monitoring occasions occurs within an active period of the discontinuous operation pattern, skipping monitoring of the control information at the at least one monitoring occasion that occurs within the active period.

In some example embodiments, the method 1000 further comprises: in accordance with a determination that a duration when the timer is running is overlapped with an active period following the non-active period of the discontinuous operation pattern, terminating the timer at a start of the active period.

In some example embodiments, the apparatus is or is comprised in a user equipment, and the device is a network device.

FIG. 11 shows a flowchart of an example method 1100 implemented at a device in accordance with some example embodiments of the present disclosure. For example, the method 1000 may be performed by the second device 120 in FIG. 1.

At block 1110, the device (e.g., the second device 120 in FIG. 1) transmits, to an apparatus (e.g., the first device 110 in FIG. 1), a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated.

At block 1120, the device transmits control information to the apparatus at the at least one monitoring occasion before activation of the discontinuous operation pattern or during a time when the discontinuous operation pattern is activated, the control information at least indicating a state transition of the cell between an active state and a non-active state.

In some example embodiments, the method 1100 comprises: transmitting, to the apparatus, downlink control information indicating the monitoring occasion configuration, and/or wherein the monitoring occasion configuration is configured with a search space type of common search space associated with a predetermined group-common downlink control information format.

In some example embodiments, the apparatus is a user equipment, and the device is or is comprised in a network device.

In some example embodiments, an apparatus capable of performing any of the method 1000 (for example, the first device 110 in FIG. 1) may comprise means for performing the respective operations of the method 1000. The means may be implemented in any suitable form. For example, the means may be implemented in a circuitry or software module. The apparatus may be implemented as or included in the first device 110 in FIG. 1.

In some example embodiments, the apparatus comprises means for receiving, from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; means for monitoring the control information from the device at the at least one monitoring occasion, the control information at least indicating a state transition of the cell between an active state and a non-active state; and means for based on receiving the control information from the device, determining, from the control information, the state transition of the cell between the active state and the non-active state.

In some example embodiments, the means for receiving the monitoring occasion configuration comprises means for receiving, from the device, downlink control information indicating the monitoring occasion configuration and/or wherein the monitoring occasion configuration is configured with a search space type of common search space associated with a predetermined group-common downlink control information format.

In some example embodiments, the monitoring occasion configuration comprises a first monitoring occasion configuration for control information before the activation of the discontinuous operation pattern, first monitoring occasion configuration comprising at least one of the following: a first reference boundary, the first reference boundary comprising a boundary of a time-domain resource unit, a first start offset relative to the first reference boundary to indicate when the first monitoring occasion configuration is applied, or a first periodicity of monitoring occasions.

In some example embodiments, the time-domain resource unit comprises a system frame number, a slot, or a symbol.

In some example embodiments, the control information detected before the activation of the discontinuous operation pattern comprises a first indication of transitioning the cell from the active state to the non-active state before a configured start of the discontinuous operation pattern; and wherein the apparatus is caused to perform: based on receiving the control information before the configured start of the discontinuous operation pattern, determining that the cell is transitioned to the non-active state.

In some example embodiments, the monitoring occasion configuration comprises a second monitoring occasion configuration for control information during an active period of the discontinuous operation pattern, the second monitoring occasion configuration comprising at least one of the following: a second reference boundary, the second reference boundary comprising a reference time within the active period of the discontinuous operation pattern, a second start offset relative to the second reference boundary to indicate when the second monitoring occasion configuration is applied, or a second periodicity of monitoring occasions.

In some example embodiments, the control information detected during the active period of the discontinuous operation pattern comprises a second indication of early termination of the active period or a third indication of deactivation of the discontinuous operation pattern; and wherein the means for determining, from the control information, the state transition of the cell comprises: means for, based on receiving the control information during the active period of the discontinuous operation pattern, determining that the cell is transitioned from the active state to the non-active state or that the discontinuous operation pattern is deactivated.

In some example embodiments, the means for determining, from the control information, the state transition of the cell further comprises: means for, in accordance with a determination that the detected control information comprises the second indication of early termination of the active period, determining a shifted start of a new non-active-to-active periodicity starting with a non-active period or a start of a non-active period followed by a new non-active-to-active periodicity in the discontinuous operation pattern.

In some example embodiments, the monitoring occasion configuration comprises a third monitoring occasion configuration for control information during a non-active period of an activated discontinuous operation pattern, the third monitoring occasion configuration comprising at least one of the following: a third reference boundary, the third reference boundary comprising a configured boundary of switching from an active period to a non-active period of the discontinuous operation pattern, or a latest boundary of switching from an active period to a non-active period of the discontinuous operation pattern triggered by the control information from the device; a third start offset relative to the third reference boundary to indicate when the third monitoring occasion configuration is applied; or a third periodicity of monitoring occasions.

In some example embodiments, the third monitoring occasion configuration configures a first plurality of monitoring occasions for monitoring control information, and wherein the apparatus further comprises: means for skipping monitoring of the control information at at least one of the first plurality of monitoring occasions monitoring occasion that occurs within an active period of the discontinuous operation pattern; and means for monitoring the control information at at least one of the first plurality of monitoring occasions that occurs within a non-active period of the discontinuous operation pattern.

In some example embodiments, the control information comprises at least one of the following: a fourth indication of transitioning from the non-active state to the active state, a fifth indication of not transitioning from the non-active state to the active state, or a temporary active duration.

In some example embodiments, the means for determining, from the control information, the state transition of the cell comprises: means for, during the non-active period of the discontinuous operation pattern, means for, in accordance with a determination that no control information is detected according to the third monitoring occasion configuration or in accordance with a determination that the detected control information comprises the fifth indication of not transitioning from the non-active state to an active state, determining that the cell is in the non-active state; and means for, in accordance with a determination that the detected control information comprises the fourth indication of transitioning from the non-active state to the active state, determining that the cell is transitioned from the non-active state to the active state upon the detection of the control information or after a predetermined delay of time.

In some example embodiments, the apparatus further comprises: means for, based on determining that the cell is transitioned from the non-active state to the active state, starting a timer with a temporary active duration; and means for determining that the cell is in the active state within a duration when the timer is running.

In some example embodiments, the temporary active duration is determined based on at least one of the following: a configured duration of an active period of the discontinuous operation pattern, or a duration determined based on a minimum delay related to a service to be performed during the non-active period.

In some example embodiments, the apparatus further comprises: means for receiving, from the device, configuration information indicating allowed operations to be performed within a duration when the timer is running.

In some example embodiments, the apparatus further comprises: means for receiving, from the device and within a duration when the timer is running, an indication of an extended running duration of the timer; and means for setting the timer with the extended running duration.

In some example embodiments, the monitoring occasion configuration comprises a fourth monitoring occasion configuration for control information within the duration when the timer is running. In some example embodiments, the means for monitoring comprises: within the duration when the timer is running, means for monitoring, according to the fourth monitoring occasion configuration, the control information within the duration when the timer is running; and means for detecting, at a monitoring occasion, control information at least comprising the indication of an extended running duration of the timer.

In some example embodiments, the fourth monitoring occasion configuration comprises at least one of the following: a fourth reference boundary, the fourth reference boundary comprising a monitoring occasion in which the control information comprising the fourth indication of transitioning from the non-active state to the active state is detected, or an expiration of the temporary active duration of the timer; a fourth start offset relative to the fourth reference boundary to indicate when the fourth monitoring occasion configuration is applied; or a fourth periodicity of monitoring occasions.

In some example embodiments, the means for determining, from the control information, the state transition of the cell comprises: means for, in accordance with a determination that no control information is detected according to the fourth monitoring occasion configuration or in accordance with a determination that the detected control information comprises an indication of not transitioning to the active state, determining that the cell transitions to the non-active state after an expiration of the timer.

In some example embodiments, the fourth monitoring occasion configuration configures a second plurality of monitoring occasions for monitoring control information, and the apparatus further comprises: in accordance with a determination that at least one of the second plurality of monitoring occasions occurs within an active period of the discontinuous operation pattern, skipping monitoring of the control information at the at least one monitoring occasion that occurs within the active period.

In some example embodiments, the apparatus further comprises: in accordance with a determination that a duration when the timer is running is overlapped with an active period following the non-active period of the discontinuous operation pattern, means for terminating the timer at a start of the active period.

In some example embodiments, the apparatus is or is comprised in a user equipment, and the device is a network device.

In some example embodiments, the apparatus further comprises means for performing other operations in some example embodiments of the method 1000 or the first device 110. In some example embodiments, the means comprises at least one processor; and at least one memory storing instructions that, when executed by the at least one processor, cause the performance of the apparatus.

In some example embodiments, an apparatus capable of performing any of the method 1100 (for example, the second device 120 in FIG. 1) may comprise means for performing the respective operations of the method 1100. The means may be implemented in any suitable form. For example, the means may be implemented in a circuitry or software module. The device may be implemented as or included in the second device 120 in FIG. 1.

In some example embodiments, the device comprises means for transmitting, to an apparatus, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; and means for transmitting control information to the apparatus at the at least one monitoring occasion before activation of the discontinuous operation pattern or during a time when the discontinuous operation pattern is activated, the control information at least indicating a state transition of the cell between an active state and a non-active state.

In some example embodiments, the means for transmitting comprises means for transmitting, to the apparatus, downlink control information indicating the monitoring occasion configuration. In some example embodiments, the monitoring occasion configuration is configured with a search space type of common search space associated with a predetermined group-common downlink control information format.

In some example embodiments, the apparatus is a user equipment, and the device is or is comprised in a network device.

In some example embodiments, the device further comprises means for performing other operations in some example embodiments of the method 1100 or the second device 120. In some example embodiments, the means comprises at least one processor; and at least one memory storing instructions that, when executed by the at least one processor, cause the performance of the device.

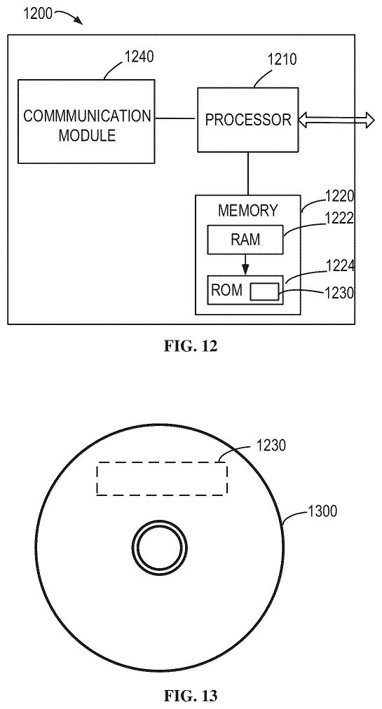

FIG. 12 is a simplified block diagram of a device 1200 that is suitable for implementing example embodiments of the present disclosure. The device 1200 may be provided to implement a communication device, for example, the first device 110 or the second device 120 as shown in FIG. 1. As shown, the device 1200 includes one or more processors 1210, one or more memories 1220 coupled to the processor 1210, and one or more communication modules 1240 coupled to the processor 1210.

The communication module 1240 is for bidirectional communications. The communication module 1240 has one or more communication interfaces to facilitate communication with one or more other modules or devices. The communication interfaces may represent any interface that is necessary for communication with other network elements. In some example embodiments, the communication module 1240 may include at least one antenna.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The instructions of the program 1230 may include instructions for performing operations/acts of some example embodiments of the present disclosure. The program 1230 may be stored in the memory, e.g., the ROM 1224. The processor 1210 may perform any suitable actions and processing by loading the program 1230 into the RAM 1222.

The example embodiments of the present disclosure may be implemented by means of the program 1230 so that the device 1200 may perform any process of the disclosure as discussed with reference to FIG. 3 to FIG. 11. The example embodiments of the present disclosure may also be implemented by hardware or by a combination of software and hardware.

In some example embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 13 shows an example of the computer readable medium 13 which may be in form of CD, DVD or other optical storage disk. The computer readable medium 1300 has the program 1230 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus at least to perform:
receiving, from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated;
monitoring the control information from the device at the at least one monitoring occasion, the control information at least indicating a state transition of the cell between an active state and a non-active state; and
based on receiving the control information from the device, determining, from the control information, the state transition of the cell between the active state and the non-active state.

2. The apparatus of claim 1, wherein the apparatus is caused to receive, from the device, downlink control information indicating the monitoring occasion configuration and/or
wherein the monitoring occasion configuration is configured with a search space type of common search space associated with a predetermined group-common downlink control information format.

3. The apparatus of claim 1, wherein the monitoring occasion configuration comprises a first monitoring occasion configuration for control information before the activation of the discontinuous operation pattern, the first monitoring occasion configuration comprising at least one of the following:
a first reference boundary, the first reference boundary comprising a boundary of a time-domain resource unit,
a first start offset relative to the first reference boundary to indicate when the first monitoring occasion configuration is applied, or
a first periodicity of monitoring occasions.

4. The apparatus of claim 3, wherein the time-domain resource unit comprises a system frame number, a slot, or a symbol.

5. The apparatus of claim 3, wherein the control information detected before the activation of the discontinuous operation pattern comprises a first indication of transitioning the cell from the active state to the non-active state before a configured start of the discontinuous operation pattern; and
wherein the apparatus is caused to perform:
based on receiving the control information before the configured start of the discontinuous operation pattern, determining that the cell is transitioned to the non-active state.

6. The apparatus of claim 1, wherein the monitoring occasion configuration comprises a second monitoring occasion configuration for control information during an active period of the discontinuous operation pattern, the second monitoring occasion configuration comprising at least one of the following:
a second reference boundary, the second reference boundary comprising a reference time within the active period of the discontinuous operation pattern,
a second start offset relative to the second reference boundary to indicate when the second monitoring occasion configuration is applied, or
a second periodicity of monitoring occasions.

7. The apparatus of claim 6, wherein the control information detected during the active period of the discontinuous operation pattern comprises a second indication of early termination of the active period or a third indication of deactivation of the discontinuous operation pattern; and
wherein the apparatus is caused to perform:
based on receiving the control information during the active period of the discontinuous operation pattern, determining that the cell is transitioned from the active state to the non-active state or that the discontinuous operation pattern is deactivated,
wherein the apparatus is caused to perform:
in accordance with a determination that the detected control information comprises the second indication of early termination of the active period, determining a shifted start of a new non-active-to-active periodicity starting with a non-active period or a start of a non-active period followed by a new non-active-to-active periodicity in the discontinuous operation pattern.

8. The apparatus of claim 1, wherein the monitoring occasion configuration comprises a third monitoring occasion configuration for control information during a non-active period of an activated discontinuous operation pattern, the third monitoring occasion configuration comprising at least one of the following:
a third reference boundary, the third reference boundary comprising a configured boundary of switching from an active period to a non-active period of the discontinuous operation pattern, or a latest boundary of switching from an active period to a non-active period of the discontinuous operation pattern triggered by the control information from the device,
a third start offset relative to the third reference boundary to indicate when the third monitoring occasion configuration is applied, or
a third periodicity of monitoring occasions.

9. The apparatus of claim 8, wherein the third monitoring occasion configuration configures a first plurality of monitoring occasions for monitoring control information, and wherein the apparatus is further caused to perform:
skipping monitoring of the control information at at least one of the first plurality of monitoring occasions monitoring occasion that occurs within an active period of the discontinuous operation pattern; and
monitoring the control information at at least one of the first plurality of monitoring occasions that occurs within a non-active period of the discontinuous operation pattern.

10. The apparatus of claim 8, wherein the control information comprises at least one of the following:
a fourth indication of transitioning from the non-active state to the active state,
a fifth indication of not transitioning from the non-active state to the active state, or
a temporary active duration.

11. The apparatus of claim 8, wherein the apparatus is caused to perform: during the non-active period of the discontinuous operation pattern,
in accordance with a determination that no control information is detected according to the third monitoring occasion configuration or in accordance with a determination that the detected control information comprises the fifth indication of not transitioning from the non-active state to an active state,
determining that the cell is in the non-active state; and
in accordance with a determination that the detected control information comprises the fourth indication of transitioning from the non-active state to the active state,
determining that the cell is transitioned from the non-active state to the active state upon the detection of the control information or after a predetermined delay of time,
wherein the apparatus is further caused to perform:
based on determining that the cell is transitioned from the non-active state to the active state,
starting a timer with a temporary active duration; and
determining that the cell is in the active state within a duration when the timer is running.

12. The apparatus of claim 10, wherein the temporary active duration is determined based on at least one of the following:
a configured duration of an active period of the discontinuous operation pattern, or
a duration determined based on a minimum delay related to a service to be performed during the non-active period.

13. The apparatus of claim 11, wherein the apparatus is further caused to perform:
receiving, from the device, configuration information indicating allowed operations to be performed within a duration when the timer is running.

14. The apparatus of claim 11, wherein the apparatus is further caused to perform:
receiving, from the device and within a duration when the timer is running, an indication of an extended running duration of the timer; and
setting the timer with the extended running duration.

15. The apparatus of claim 14, wherein the monitoring occasion configuration comprises a fourth monitoring occasion configuration for control information within the duration when the timer is running, and
wherein the apparatus is caused to perform: within the duration when the timer is running,
monitoring, according to the fourth monitoring occasion configuration, the control information within the duration when the timer is running; and
detecting, at a monitoring occasion, control information at least comprising the indication of an extended running duration of the timer,
wherein the fourth monitoring occasion configuration comprises at least one of the following:
a fourth reference boundary, the fourth reference boundary comprising a monitoring occasion in which the control information comprising the fourth indication of transitioning from the non-active state to the active state is detected, or an expiration of the temporary active duration of the timer,
a fourth start offset relative to the fourth reference boundary to indicate when the fourth monitoring occasion configuration is applied, or
a fourth periodicity of monitoring occasions.

16. The apparatus of claim 15, wherein the apparatus is further caused to perform:
in accordance with a determination that no control information is detected according to the fourth monitoring occasion configuration or in accordance with a determination that the detected control information comprises an indication of not transitioning to the active state, determining that the cell transitions to the non-active state after an expiration of the timer.

17. The apparatus of claim 15, wherein the fourth monitoring occasion configuration configures a second plurality of monitoring occasions for monitoring control information, and the apparatus is further caused to perform:
in accordance with a determination that at least one of the second plurality of monitoring occasions occurs within an active period of the discontinuous operation pattern, skipping monitoring of the control information at the at least one monitoring occasion that occurs within the active period.

18. The apparatus of claim 11, wherein the apparatus is further caused to perform:
in accordance with a determination that a duration when the timer is running is overlapped with an active period following the non-active period of the discontinuous operation pattern,
terminating the timer at a start of the active period.

19. A device comprising:
at least one processor; and
at least one memory storing instructions that, when executed by the at least one processor, cause the device at least to perform:
transmitting, to an apparatus, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated; and
transmitting control information to the apparatus at the at least one monitoring occasion before or during activation of the discontinuous operation pattern, the control information at least indicating a state transition of the cell between an active state and a non-active state.

20. A method comprising:
receiving, at an apparatus and from a device, a monitoring occasion configuration for control information related to a discontinuous operation pattern of a cell, the discontinuous operation pattern comprising a pattern of at least one of a discontinuous transmission operation or a discontinuous reception operation, the monitoring occasion configuration indicating at least one monitoring occasion that is before activation of the discontinuous operation pattern or during a time when the discontinuous operation pattern is activated;
monitoring the control information from the device at the at least one monitoring occasion, the control information at least indicating a state transition of the cell between an active state and a non-active state; and
based on receiving the control information from the device, determining, from the control information, the state transition of the cell between the active state and the non-active state.
